(19) United States
(12) Patent Application Publication
(10) Pub. No.: US 2016/0311289 A1
(43) Pub. Date: Oct. 27, 2016

(54) SEALING DEVICE FOR AIR-CONDITIONING SYSTEM

(71) Applicant: Delphi Automotive Systems Luxembourg SA, Bascharage (LU)

(72) Inventor: David Pihet, Beuvillers (FR)

(73) Assignee: Delphi Automotive Systems Luxembourg, Bascharage (LU)

(21) Appl. No.: 14/372,782

(22) PCT Filed: Dec. 21, 2012
(86) PCT No.: PCT/EP2012/076700

§ 371 Date: Jan. 5, 2015

(30) Foreign Application Priority Data
Jan. 19, 2012 (FR) 1250521

(51) Int. Cl. B60H 1/00

(52) U.S. Cl. CPC B60H 1/00521; B60H 2001/00635

(57) ABSTRACT

The invention relates to a sealing device for sealing and vibration isolation intended to plug the space between a heat exchanger and a pipe of a ventilation and air-conditioning system of a vehicle. The sealing device includes a thin closed frame, an inner seal able to plug the inner space situated between the frame and the exchanger, an outer seal able to plug the outer space situated between the frame and the pipe, inner vibration-damping studs extending from the inner face of the frame and being able to be in contact with the heat exchanger, outer vibration-damping studs extending from the outer face of the frame and being able to be in contact with the pipe for circulation of air, inner and outer studs together isolating the pipe from the exchanger, the inner and outer seals and the inner and outer studs being attached to the frame.

### CROSS-REFERENCE TO RELATED APPLICATION

This application claims the benefit under 35 U.S.C. §371 of published PCT Patent Application Number PCT/EP 2012/076700, filed Dec. 21, 2012, claiming priority to French patent application number FR1250521 filed on Jan. 19, 2012, and published as WO2012/107601 on Jul. 25, 2013, the entire contents of which is hereby incorporated by reference herein.

### TECHNICAL FIELD OF INVENTION

The invention relates to an air-conditioning system in which a heat exchanger is passed through by a flow of air circulating in a pipe with a sealing device placed in the space between the exchanger and the pipe.

### BACKGROUND OF INVENTION

Air-conditioning systems comprise pipes for circulation of air, and heat exchangers. The exchangers, generally parallelepipedal, are arranged in one of the pipes and are passed through by a flow of air. The exchanger being slightly smaller than the pipe in which it is placed, a space exists around the exchanger and it is essential that it is plugged in a sealed manner in order to force the flow of air to wholly pass through the exchanger without being able to bypass it. In addition, vibrations propagated through the structure can cause the pipe to vibrate and that could damage the heat exchanger the parts of which are joined by brazing if the exchanger vibrates in its turn. Conversely, vibrations can arise due to the continuous flow of air passing through the heat exchanger and these can be just as damaging to parts or cause discomfort. Thus in addition to sealing it is important to prevent the transmission of the vibrations between the exchanger and the pipe.

To this dual end of sealing and isolation it is known to stick strips of foam around the exchanger, the foam being compressed after mounting in the space surrounding the exchanger. The foam by itself ensures the dual function of sealing and vibration isolation. This widely distributed solution has several disadvantages. It is firstly known that the placing in position of the adhesive foam is a lengthy manual operation subject to errors. Then, the permanently compressed foam loses its elasticity and progressively with the ageing of the system the seal and the isolation deteriorate. In addition, the foam can be the breeding ground of bacteria the presence of which generates disagreeable odors. It is therefore important to propose a simple alternative system which resolves these difficulties.

### SUMMARY OF THE INVENTION

The present invention resolves the problems mentioned above by proposing a sealing and vibration isolation device intended to plug the space between a heat exchanger and a ventilation and air-conditioning system pipe of a vehicle. A flow of air circulates in the pipe in a longitudinal direction and passes through the exchanger from its upstream face to its downstream face. The sealing device comprises a thin shaped frame closed so as to have an outer face facing the pipe and an inner face facing the exchanger, the two faces extending from an upstream edge to a downstream edge, the frame in place being able to be at an intermediate distance from the exchanger and from the pipe. The device comprises in addition an inner seal able to plug the inner space situated between the frame and the exchanger, an outer seal able to plug the outer space situated between the frame and the pipe, inner vibration-damping studs extending from the inner face of the frame so as to be able to be in contact with the heat exchanger and outer vibration-damping studs extending from the outer face of the frame so as to be able to be in contact with the air circulation pipe. The inner and outer seals and the inner and outer studs are advantageously attached to the frame so as to form an easily-handled integrated assembly. Moreover, the frame comprises a stop extending in the inner direction from the downstream edge of the frame so that the device being placed in position around the exchanger, the stop is in contact against the downstream face of the exchanger thereby ensuring the correct positioning of the device relatively to the exchanger.

In addition, the inner seal is a lipped seal extending from the upstream edge of the frame so that the device placed in position around the exchanger, the inner seal comes into continuous contact against the periphery of the upstream face of the exchanger and thus plugs the whole of the inner space. Also, the outer seal is a lipped seal extending from the upstream edge of the frame so that the device placed in position around the exchanger and in the pipe, the outer seal comes into continuous contact against the walls of the pipe and thus plugs the outer space. The inner and outer seals and studs are made of elastomers advantageously over-molded on the frame so as to ensure easy formation of the integrated device. Thus formed the device independently ensures the functions of sealing and vibration isolation which greatly simplifies the assembly operations. Moreover, the proposed device is little affected by the variations in dimensions from one part to the other, variations due to the dimensional manufacturing tolerances and, therefore, the sealing and vibration isolation functions are better ensured than previously. Lastly, the over-molding of the seals and studs in water-repellent materials and the profile selected for these elements ensures that, in the case of a heat exchanger of evaporator type, the condensate waters are not retained and can be removed.

The invention also relates to an air-conditioning system for a vehicle comprising a pipe for circulation of a flow of air, a heat exchanger arranged in the pipe and able to be passed through by a flow of air circulating in the pipe and a sealing device formed in accordance with the preceding paragraphs and arranged between the pipe and the exchanger.

The invention relates in addition to a process for ensuring sealing and vibration isolation between an air pipe and a heat exchanger of an air-conditioning system of a vehicle, the process comprising the following steps: providing a sealing device formed in accordance with the preceding description; arranging the said device around the heat exchanger; and arranging the exchanger and device assembly in the pipe for circulation of the fluid.

### BRIEF DESCRIPTION OF DRAWINGS

An embodiment of the invention is now described by means of the following figures.

FIG. 1 is an exploded perspective view of a part of a vehicle air-conditioning system in particular an air pipe, the heat exchanger and the sealing device in accordance with the invention.

FIG. 2 is a perspective view similar to FIG. 1, the elements being assembled.

FIG. 3 is a cross-section of the sealing device of FIG. 1.

FIG. 4 is an isometric view of the device in accordance with the invention.

FIG. 5 is a detail in section of a vibration-damping stud of the device of FIGS. 1, 2, 3 and 4.

### DETAILED DESCRIPTION

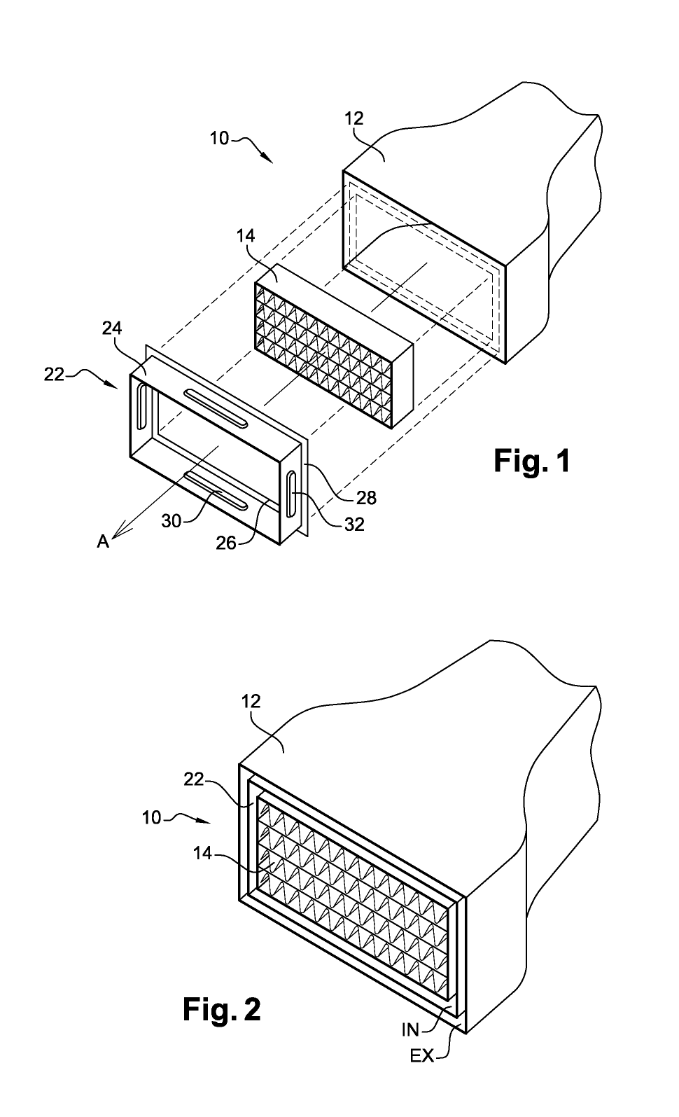

FIG. 1 shows a part of an air-condrtioning system 10 and sore particularly the outlet of an air pipe 12, a heat exchanger 14 and a sealing device 22. The circulation pipe 12 is designed to receive the rectangular paraileiepipedai exchanger 14 and therefore locally has a complementary rectangular section. The flow of air circulates along a longitudinal axis A perpendicular to the rectangular section, and therefore also to the heat exchanger 14. The description is based on a paraileiepipedai system bat the invention is applicable without difficulty to other beat exchange geometries. The pipe 12 shown here is formed by molding plastic material, but could also be formed m another material such as steel. The exchanger 14 for its part is of conventional design. It has a general rectangular paraileiepipedai form with an upstream face 16 and a downstream face 18 perpendicular to the direction of the flow, the periphery 20 of the exchanger 14 comprising four peripheral longitudinal faces. Moreover, the exchanger 14 comprises two parallel tanks of fluid, transversally linked by tubes between which are brazed line corrugated fins. One of the tanks is provided with an inlet and an outlet for a fluid, internal separations obliging the fluid to circulate from one tank to the other through transversal tubes. FIG. 1 also shows the sealing device 22 having the form of a rectangular frame able to be inserted between the heat exchanger 14 and the pipe 12 for circulation of air. The aim. of this device being to prevent passage of the flow of air by the periphery of the exchanger.

FIG. 2 shows the assembly mourned, the sealing device 22 being arranged on the exchanger 14 and the assembly being positioned inside the pipe 12.

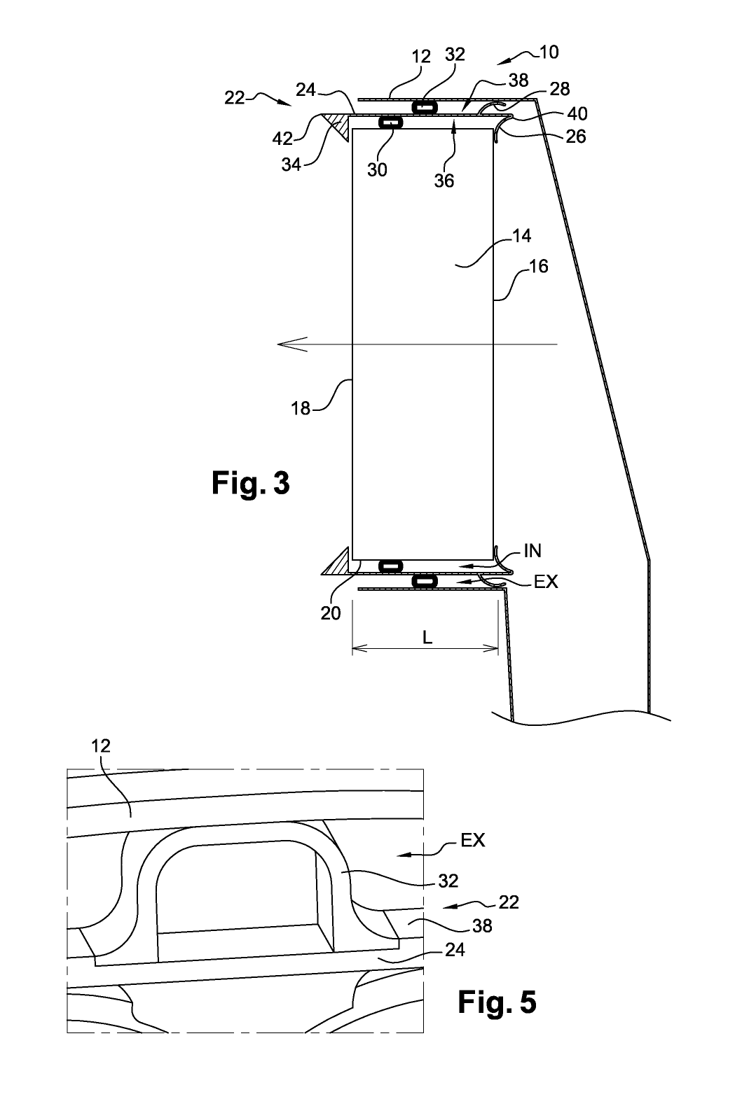

FIG. 3 is a section, in a longitudinal lane, of the assembly mounted. The sealing device 22 comprises a name 24 provided with an inner lipped seal 26, with an outer lipped seal 28, with Inner vibration-damping studs 30, with outer vibration-damping studs 32 and with a stop 34.

The frame 24 is itself formed closed and relatively thin and substantially of the same width as the heat exchanger 14, which width is measured between the upstream 16 and downstream 18 faces of the exchanger 14. The frame 24 then presents an inner lace 36 opposite to an outer lace 38, the two faces, 36, 38 extending from an upstream edge 40 to a downstream edge 42 of the frame. Thus formed, the frame 24 can he housed between the exchanger 14 and the pipe 12, without touching either of the two elements. The space separating the exchanger 14 from the pipe 12 for circulation of air is then divided between an inner space IN between the inner face 36 of the frame and the periphery 20 of the exchanger and an outer space EX situated between the outer face 38 of the frame and the circulation pipe 12.

At the downstream edge 42, the frame 24 is provided with the inner stop 34 which facilitates the placing In position and maintenance of the sealing device 22, the mounting operator slipping the device 22 onto the exchanger 14 until the contact is felt of the stop 34 against the downstream face 18 of the exchanger. It is noted that the frame 24 of the device can be provided with a plurality of stops for example one en each of the races.

The inner lipped seal 26 extends all around the frame 24 without interruption. It extends from the upstream edge 40 of the frame, or from the inner face 36 but in the proximity of the upstream edge 40. Thus, as shown in FIG. 3 when the frame 24 is in place and the stop 34 in contact the inner seal 26 is naturally in place to come into contact against the upstream face 16 of the exchanger 14 and thus sea) the inner space IN. Due to the inner sea) 26 and the stop 34, the sealing device 22 remains in place around the exchanger 14 and is renamed, slightly jammed between the stop 34 and the inner seal 26.

The outer lipped seal 28 for its part extends in die opposite direction to the inner seal 26, from the outer face 38 of the frame and also without interruption ail around the frame 24. As shown in FIG. 3, in the mounted position the outer seal 28 is in continuous circumferential contact with the wall of the circulation pipe 12 thus in sealed manner plugging the outer space EX. In the example selected in FIG. 3 the device is firstly placed in position around the exchanger 14 and then the assembly is inserted in the circulation pipe 12.

Moreover the frame 24 of the device is provided with inner 30 and outer 32 vibration-damping studs specially intended for the acoustic isolation of the exchanger 14 with regard to the pipe 12. The inner studs 30 extend from the inner face 36 of the frame to their apices which come into contact against the periphery 20 of the exchanger. Symmetrically, the outer studs 32 extend from the outer face 38 of the frame to their apices which come into contact against the wall of the circulation pipe 12. Inner 30 and outer 32 studs are present on the four faces of the frame 24 and this in order to provide vibration isolation in all the transversal directions.

One embodiment consists of molding the frame 24 in a plastic material permuting slight flexibility so as to facilitate placing in position, but remaining sufficiently stiff to naturally retain its rectangular form. The inner 26 and outer 28 seals and the inner 30 and outer 32 vibration-damping studs are for their part over-molded on the frame 24 so as to form an integrated device which is easily manufactured and handled and able to efficiently fulfill the functions of sealing and acoustic isolation.

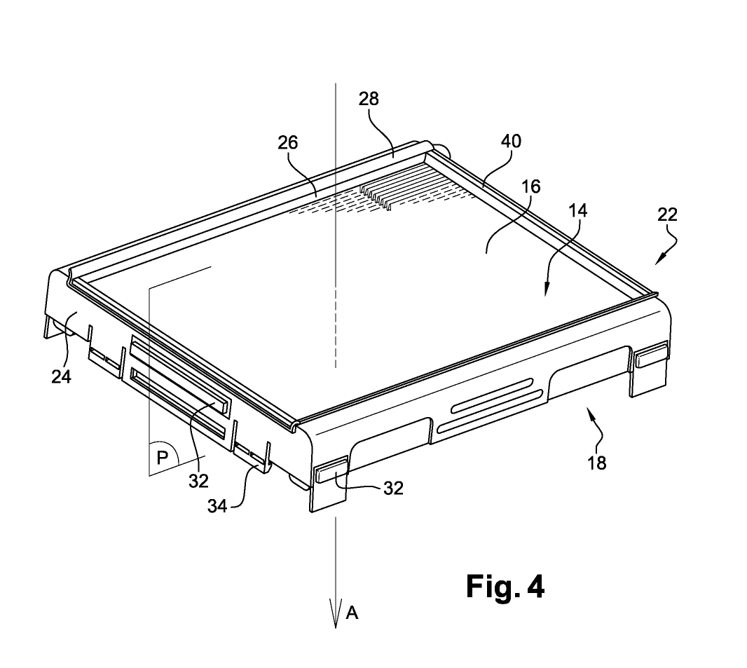

FIG. 4 shows the sealing device 22 placed in position on the heat exchanger 14, the upstream face 16 of which is clearly visible and the inner seal 26 entirely plugs the inner space IN. In this representation the frame 24 is provided with outer vibration-damping studs 32 which are differently arranged depending on the faces of the frame. Thus, a first visible lace, on the left in FIG. 4, is provided with a single elongated and centered stud 32, while a second visible face, on the right in FIG. 4, is provided with two short studs 32 arranged at the ends of the face of the frame.

FIG. 5 shows in more detailed manner an outer vibration-damping stud 32, over-molded on the frame 24. In a longitudinal plane of the section lb identified in FIG. 4, the stud has the form of a hollow dome of substantially uniform thickness, in fact, as can be seen in FIGS. 1 and 4, the stud 32 is elongate along a transversal axis perpendicular to the plane of section P so as to be in long contact against the wail of the pipe 12. Moreover, as can also be seen in FIG. 3, the vibration-damping stud 32 is over-molded on the frame 24 in a location of the frame designed to this end, the location being in a slight hollow relative to the outer face 38. The inner vibration-damping studs 30 are designed on the same principle. Thus formed, the over-molded studs are attached to the frame 24 on the one hand due to the very adherence of the materials but also due to mechanical holding in place provided by the location in a slight hollow.

The inner vibration-damping studs assist the positioning of the sealing device around the exchanger and the outer vibration-damping studs assist the positioning of the heat exchanger provided with the sealing device inside the air pipe. The dimensional variations inherent in the manufacture of the exchangers of the same model are advantageously absorbed by the vibration-damping studs which can easily be deformed and remain compressed so as to ensure excellent holding in place of the assembly.

Due to the separation of the functions of sealing and of acoustic isolation, fine adjustment of the acoustic isolation is facilitated as h is independent of the sealing function.

A complementary alternative to the above description is to form a sealing device which is inserted and placed in position in the pipe 12 before the exchanger 14 is placed in the device. In this case the stop would extend in the outer direction to come into contact with edges of the pipe. Similarly a frame can be provided with an outer stop to position the device in the pipe and an inner stop to position the exchanger in the device.

1. A sealing device for sealing and vibration isolation configured to plug a peripheral space situated between a heat exchanger and a pipe of a vehicle ventilation and air-conditioning system that has a flow of air circulating in the pipe in a longitudinal direction and passing through the heat exchanger from an upstream face to a downstream face, wherein the device comprises:
a thin frame closed so as to have an outer face facing the pipe and an inner face facing the heat exchanger, the outer face and the inner face extending from an upstream edge to a downstream edge, the frame configured to be housed in the peripheral space at an intermediate distance from the heat exchanger and from the pipe;
an inner seal configured to plug an inner space between the frame and the heat exchanger;
an outer seal configured to plug the outer space between the frame and the pipe;
inner vibration-damping studs extending from the inner face of the frame so as to be in contact with the heat exchanger; and
outer vibration-damping studs extending from the outer face of the frame so as to be in contact with the pipe for circulation of air, wherein
the inner seal, the outer seal, the inner stud, and outer stud are attached to the frame.

2. The device as described in claim 1, wherein the frame further comprises a stop extending from the downstream edge of the frame so that the stop is in contact against the downstream face of the heat exchanger thereby ensuring the correct longitudinal positioning of the device relative to the heat exchanger when the device is placed in position around the heat exchanger.

3. The device as described in claim 1, wherein the inner seal is a lipped seal extending from the upstream edge of the frame so that the inner seal is able to come into continuous contact against the periphery of the upstream face of the heat exchanger and thus plugs the entirety of the inner space when the device is placed in position around the heat exchanger.

4. The device as described in claim 1, wherein the outer seal is a lipped seal extending from the upstream edge of the frame so that the outer seal is able to come into continuous contact against the walls of the pipe and thus plugs the outer space when the device is placed in position around the heat exchanger and in the pipe.

5. The device as described in claim 1, wherein the inner and outer seals and studs are over-molded on the frame.

6. The device as described in claim 1, wherein the inner and outer seals and studs are made of water-repellent elastomer.

7. An air-conditioning system for a vehicle, said system comprising:
a pipe for circulation of a flow of air;
a heat exchanger arranged in the pipe and able to be passed through by a flow of air circulating in the pipe; and
a sealing device being arranged between the pipe and the heat exchanger so that the flow of air cannot bypass the heat exchanger.

8. A process for providing sealing and vibration isolation between an air pipe and a heat exchanger of an air-conditioning system of a vehicle, the process comprising the following steps:
providing a sealing device;
arranging the device around the heat exchanger; and
arranging the heat exchanger and device assembly in the pipe for circulation of the fluid.
